(19) United States
(12) Patent Application Publication
(10) Pub. No.: US 2013/0060587 A1
(43) Pub. Date: Mar. 7, 2013

(54) DETERMINING BEST TIME TO REACH CUSTOMERS IN A MULTI-CHANNEL WORLD ENSURING RIGHT PARTY CONTACT AND INCREASING INTERACTION LIKELIHOOD

(71) Applicants: Halil Bayrak, Hillsboro, OR (US); Ali A. Bulbul, Beaverton, OR (US); Erik T. Conser, Portland, OR (US); Guillaume de Bergh, Portland, OR (US); Chitra Dorai, Chappaqua, NY (US); Alejandro Veen, New York, NY (US)

(72) Inventors: Halil Bayrak, Hillsboro, OR (US); Ali A. Bulbul, Beaverton, OR (US); Erik T. Conser, Portland, OR (US); Guillaume de Bergh, Portland, OR (US); Chitra Dorai, Chappaqua, NY (US); Alejandro Veen, New York, NY (US)

(73) Assignee: INTERNATIONAL BUSINESS MACHINES CORPORATION, Armonk, NY (US)

(21) Appl. No.: 13/224,757

(22) Filed: Sep. 2, 2011

(51) Int. Cl. G06Q 10/04

(52) U.S. Cl. 705/7.11

(57) ABSTRACT

Estimating best time to contact a customer may include estimating a statistical model which computes a score for determining a successful contact with the customer for the time period based on a first set of historical customer contact data. A second set of historical customer contact data associated with at least one customer may be received and the score of a successful contact may be provided for the customer based on the second set of historical data and the estimated statistical model.

### FIELD

The present application relates generally to computer applications and more particularly to determining best time to reach customers in a multi-channel world ensuring right party contact and increasing interaction likelihood.

### BACKGROUND

Leveraging sophisticated insights to improve risk management, channel performance and client satisfaction may allow enterprises, where a substantial portion of the business is conducted using front office operations for sales, support, account management, etc., to become more client centric. Insightful operations also may allow for continuously tailoring services offered to changing client needs. To succeed in the market place, front office operations of businesses need to strengthen client relationships and improve client experience in the different channels of interaction. Most often, this requires increasing the quality and quantity of productive interactions with the clients. The inventors in the present application have recognized that fundamental to this, is the ability to have insights about the customers such that customers can be reached at their preferred, convenient time depending on the communication channel used. This is especially the case, when businesses and organizations need to reach out and initiate a contact with their customers and clients (outbound contact attempts) or simply return customer calls as part of their customer relationship management.

Modern contact centers can handle a multitude of communication channels, such as phone, e-mail, text messaging, paper mail, telefax, instant messaging, and messages on social networks. Some of these channels can have more than one type; for instance, there may be several types of phone channels, such as Home, Work, Cell phone, etc. and there may be different types of e-mail addresses, such as private and work email addresses.

Traditionally, the timing of customer contact attempts is based on staffing capacity, customer segments, risk priorities, and may be guided by “typical” or “expected” behavior. In the call center industry, customers are increasingly asked about their preferred time to be contacted. While this information is collected, there is no systematic way of analyzing or using the captured information. In addition, the call/response patterns at the individual level are rarely utilized to guide outbound notifications. System operations such as interactive voice responses (IVRs) or the like are not set up to ensure that contacts are always made during the most convenient/preferred time for all customers increasing the likelihood that dials are converted to successful business outcomes. Contacting customers at inconvenient times or at plain unavailable times lead to wasted contact attempts, poor customer experience, dissatisfied customers and a loss of business revenue as the opportunity to convert a call/contact into business value such as a sale or obtaining a payment is lost. Often, when outbound contact campaigns are made, the phone calls are picked up by parties who are not authorized to discuss the matter, which leads to enormous waste of resources and delayed resolution. The ability to increase right party contact and the ability to have an interaction enhances all front operations.

### BRIEF SUMMARY

A method for predicting likelihood of contacting a customer in a time period, in one aspect, may include receiving a first set of historical customer contact data. The method may also include estimating a statistical model which computes a score for determining a successful contact with the customer for the time period based on the first set of historical customer contact data. The method may further include receiving a second set of historical customer contact data associated with at least one customer. The method may also include providing the score of a successful contact for said at least one customer based on the second set of historical data and the estimated statistical model.

A system for predicting likelihood of contacting a customer in a time period, in one aspect, may include a statistical model estimated based on a first set of historical customer contact data to compute a score for determining a successful contact with the customer for the time period. The system may also include a prediction module operable to receive a second set of historical customer contact data associated with at least one customer, and provide the score of a successful contact for said at least one customer based on the second set of historical data and the estimated statistical model.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 shows a matrix generated for indicating the chance of reaching a customer at a certain phone type (home, cell, work, other) during a given time slot in one embodiment of the present disclosure.

FIG. 2 is a basic component diagram showing a methodology of the present disclosure in one embodiment.

FIG. 3 illustrates historical call data for a specific customer. Such information may be available at a call center.

FIG. 4 shows a baseline associated with outbound RPC rates for home phones in one embodiment of the present disclosure.

FIG. 5 shows customer-specific features for home phones in one embodiment of the present disclosure.

FIGS. 6 and 7 show the results of best time to contact (BTTC) model of the present disclosure in one embodiment.

FIG. 8 illustrates time-weighing of call history in one embodiment of the present disclosure.

FIG. 9 illustrates the mixing weight of customer-specific features vs. baseline information in one embodiment of the present disclosure.

FIG. 10 is a flow diagram illustrating a method of determining best time to contact a customer in one embodiment of the present disclosure.

FIG. 11 illustrates an overall methodology in one embodiment of the present disclosure.

### DETAILED DESCRIPTION

The present disclosure in one aspect describes a method of producing a score indicating the best time to use a channel of a type for a specific customer. These scores may be based on historical customer data and the method may be flexible enough to handle varying levels of data availability. For customers with little or no historical data, the method may provide a “best time to contact” score that is based on general observations about the likelihood of reaching a customer in a time period. For customers with plenty of historical data, the method may provide a “best time to contact” score that closely resembles the historical reachability patterns of the customer.

The scale of “best time” may depend on the channel used to contact the customer. For phone calls, the relevant time scale may be “time of the day”, for instance, described by the one-hour time slots. For paper mailings, on the other hand, the relevant time scale may be likely to be “day of the week”, and for e-mails it may be “day of week” in combination with a coarser measure of “time of day”, such as morning/afternoon/evening. Moreover, the “best time” may also be described in relative terms—in the case of instant messages, for example, the relevant time scale may be “minutes after a customer becomes available to chat”. Similarly, the definition of a “successful contact attempt” may be different for different channels. For a phone call, a successful contact may entail (a) somebody picking up the phone, who is (b) authorized to talk about the matter, and who (c) does not immediately indicate that this is a “bad time to talk”. The combination of (a) and (b) is referred to as a “Right Party Contact” (RPC), while the combination of (a), (b), and (c) is referred to as a “Long RPC”. For an e-mail, a successful contact attempt may be defined as whether the customer responded to the email or clicked on a certain link within a specified period of time. For a paper mail, a successful contact attempt may be defined as whether the addressee mailed back a filled-out form or took a specified action by a deadline. In a multi-channel world, the time scale of “best time” and the definition of a “successful contact” may depend on the channel and possibly on the channel type.

The present disclosure in one aspect proposes a model that uses historical contact pattern data, customer metrics, customer life situations, and possibly additional variables to determine a best time to contact a customer, ensuring a right party contact. As an example, an embodiment for outbound call center operations is disclosed such that a best time to contact (or in this case “best time to call”) is determined for each customer, and for each telephone type (cellular, home, work, and other). Information about customer inbound calling behavior and situations where a preferred time is explicitly indicated by the customer can be integrated as adjustments to determine the best time to contact the customer.

Existing solutions typically do not make use of customer-specific call histories. A typical outbound calling system might recommend calling home phones between the hours of 8 a.m. and 11 a.m., then cell phones between the hours of 11 a.m. and 1 p.m., then work phones between 1 p.m. and 5 p.m., and finally home phones between 5 p.m. and 9 p.m. The methodologies in the present disclosure may improve the likelihood of reaching the customer by using customer-specific historical call patterns to guide the outbound calling systems and to guide the outbound calling by agents in the front office.

In another embodiment, the right time to e-mail or short message service (SMS) may be determined in a way that responses are ensured. Usage patterns of e-mail and cell phone SMSs used in real time mode may be utilized to mine for the best time to send e-mail or SMSs so as to improve response rates for those customers who prefer to use those channels the most.

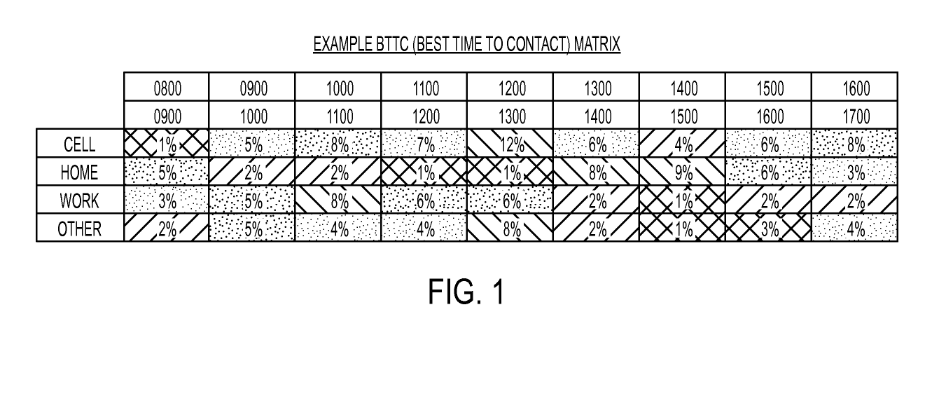

As an example application, call centers are described in connection with the methodology of the present disclosure in one embodiment. In one embodiment, the methodology of the present disclosure uses customer specific historical call patterns to determine the best time to contact a customer. For each customer in the system, the method generates a matrix with scores indicating the chance of reaching the customer at a certain phone type (home, cell, work, other) during a given time slot as shown in FIG. 1.

In one embodiment of the present disclosure, different levels of data availability for different customers/phone types/time slots are addressed by balancing an overall baseline best time to contact (BTTC) score with customer-specific information. If the outbound call history is limited (or completely absent) for a given customer (at a given phone type during a given time slot), the method in one embodiment places most (or all) of the weight on the overall baseline rate. The more customer-specific information is available for a given phone-type/time slot combination, the more weight is given to that information. The resulting weighted, customer specific BTTC score is then adjusted using inbound call information. An inbound effect is estimated for customers that actively called the call center during a certain time slot using a given phone type. Typically, if a customer contacted the call center during a given time slot, this increases the probability of reaching the customer with an outbound call during that time slot.

The present disclosure in one embodiment uses an additive model to incorporate outbound call/response history, inbound calling effects, and others. In another embodiment of the present disclosure, an adaptive/predictive model may be built that would estimate the score of the best time to contact a customer based on not only these features, but also additional model features which can be the result of aggregation, transformation (log, power, identity, etc.), categorization, or combinations thereof. This may include the total and time-weighted contact time (including the customer wait time before being connected to a live agent for customer-placed inbound calls) per time period for each customer, the total number of contact attempts and the total number of successful contacts per time period, the sum of time-weighted contact attempts and the sum of time-weighted successful contacts, a customer's risk profile, occupancy, customer life style choices, work life constraints, wait time until abandonment of an inbound call, and others. This adaptive/predictive model can be trained to learn the statistical relationships between various variables or factors affecting the likelihood of contacting a customer, and can be run every day or in intervals periodically to accommodate for the latest information. For instance, a logistic regression approach may be used to estimate coefficients of a relationship between the model features and a binary response variable, indicating whether the historical contact attempt had been successful or not.

The methodology—in one embodiment of the present disclosure—may be applied to determine the best time to contact customers using alternative channels, e.g., in an e-mail setting with different e-mail types or in a call center setting with different phone types. For example, the methodology of the present disclosure in one embodiment may consider and determine: has the customer ever used email to contact us? If so, when should we email a customer in order to maximize the likelihood of a reply? On which day of the week? During what time of the day? In addition, the answers may be different for different types of email such as personal email, work email, or the email on social network sites (e.g., Facebook™), internal messaging system. As another example, the methodology of the present disclosure in one embodiment may consider and determine in a call center context: what time of the day? e.g., call between 8 am and 9 pm; restrictions on weekends and national holidays restrictions on calling cell phones; restrictions on calling work phones; an entry on the national “do not call list”, etc. Answers may be different for different phone types such as a home phone, cellular phone, or others. Other examples include determining best time to contact customers by determining when to send out paper mail, when to send a facsimile, when to send text messages (SMS), and when to send an instant message relative to the time a customer becomes available to chat, and others.

One embodiment of the methodology of the present disclosure utilizes data, for example, historical contact patterns such as overall historical patterns, patterns specific to the individual and other data in order to determine the above answers. A trained model, e.g., a trained statistical model may generate a score or recommendation about when to contact with what medium the selected customers (or persons). Such contact recommendations may be generated based on data driven, customer-specific information and provide an increased right party contact likelihood leading to an increased likelihood of interacting productively with the customer.

The output provided by the methodology of the present disclosure may be used to schedule a number of contacts over a period of time (e.g., a number of phone calls to be scheduled over a whole day). This is especially useful in situations where there are capacity constraints. Such a Best-Time-To-Contact scheduling approach allows for the minimization of “wasted” contact attempts, which are often costly because of lost time spent by contact center agents (and therefore labor costs), in some cases phone charges or text messaging charges, and which can be bothersome for the customers.

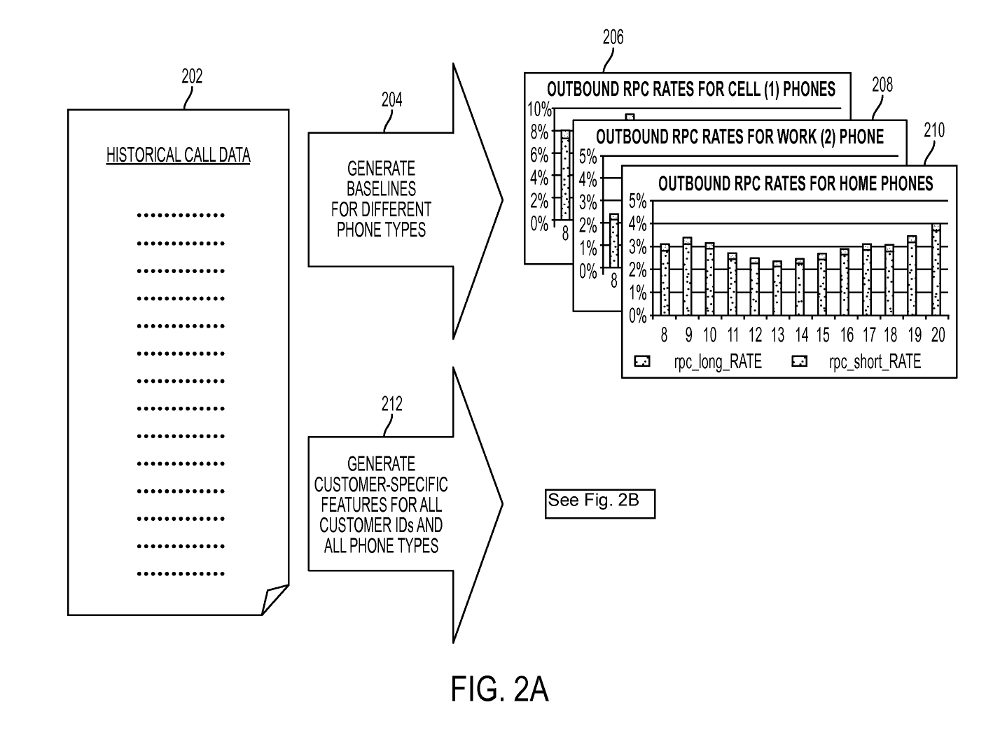

FIG. 2 is a basic component diagram showing a methodology of the present disclosure in one embodiment. This example shows determining a time to reach a customer by phone. Historical call data 202 may be collected or received. Based on the historical call data 202, baselines for different phone types may be generated at 204. The generated baselines may include outbound right party contact (RPC) rates 206, outbound RPC rates for Work (2) phone 208, outbound RPC rates for home phones 210. At 212, customer-specific features for all customer identifiers (IDs) and all phone types may be generated. The generated customer-specific features may include customer-specific features for cellular (cell) phone 214, customer-specific features for work phone 216 and customer-specific features for home phone 218.

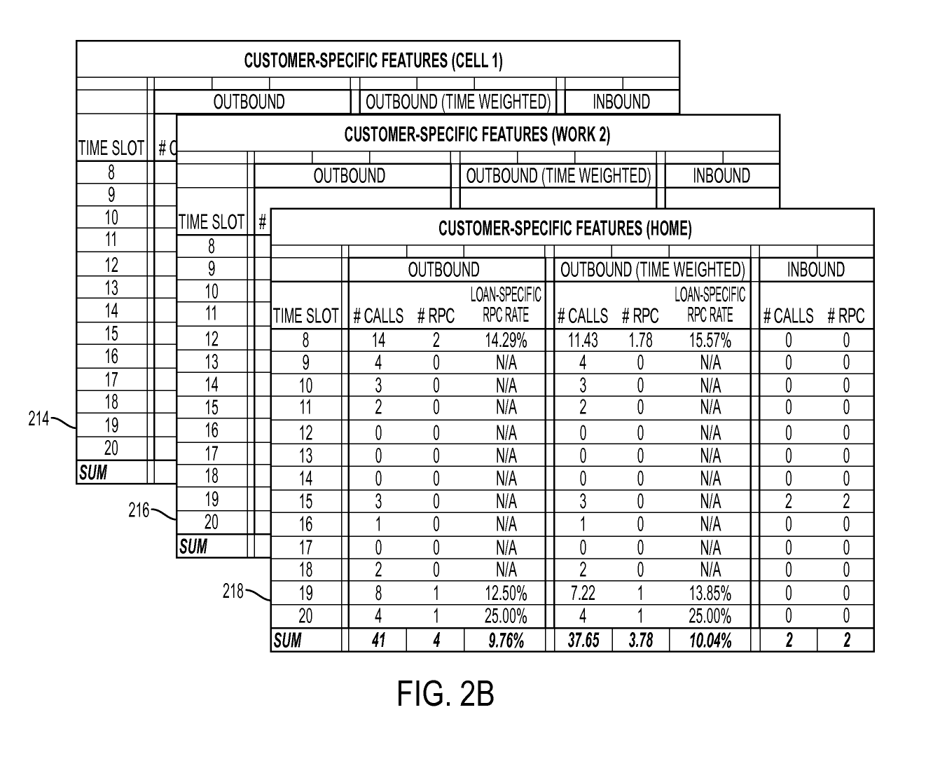

FIG. 3 illustrates historical call data for a specific customer. Such information may be available at a call center. The historical data (e.g., 202 in FIG. 2), may include various information associated with a customer such as phone types and phone number, inbound phone calls, right party contacts (RPCs). For example, the data shown in FIG. 3 includes call dates 302, call category (whether inbound or outbound call) 304, phone number of the call 306, geographical location 308, call center hour 310, call center minute 312, local time in hour 314, local time in minute 316, phone type (e.g., work phone, home phone, cell phone) 318, right party contact (e.g., 1 indicates the right party picked up the phone, 0 indicates nobody picked up the phone, or the person picking up the phone was the “wrong” party, i.e. not authorized to discuss the matter.) 320, right party contact for more than a selected time length 322, call connect time 324, speed of answer 326, and agent after call work time 328, which indicates how much time a call center agent spent after the conversation with the customer typing any the information gathered during the phone call. The right party contact for time duration (322) is useful in supporting the determination that it was a “good time” to contact the customer. For example, a phone call lasting less than one minute may indicate that a person authorized to discuss the matter picked up the phone, but immediately told the call center agent that this was not a good time to talk. The methodology of the present disclosure may determine the best or appropriate time to reach a customer by using inbound call information as much as possible, e.g., if the customer has many times called at 3 p.m., it is likely that 3 p.m. is a good time to call in order to reach the customer using an outbound phone call. In FIG. 3, the data is shown in terms of specific hours or hour time slots. In another embodiment, other time intervals may be utilized, e.g., morning of the day, afternoon of the day, evening time, or others.

In one embodiment of the present disclosure, the right party connect 320 and 322 are the response variables that the methodology of the present disclosure solves for. In one embodiment, instead of, or in addition to 1 or 0 indication, the methodology of the present disclosure may provide a probability or score of getting a successful contact (such as a right party contact that lasts at least one minute. A response variable value of 1 denotes that the right party picked up the phone and the call took up at least a predetermined length of time, e.g., one minute.

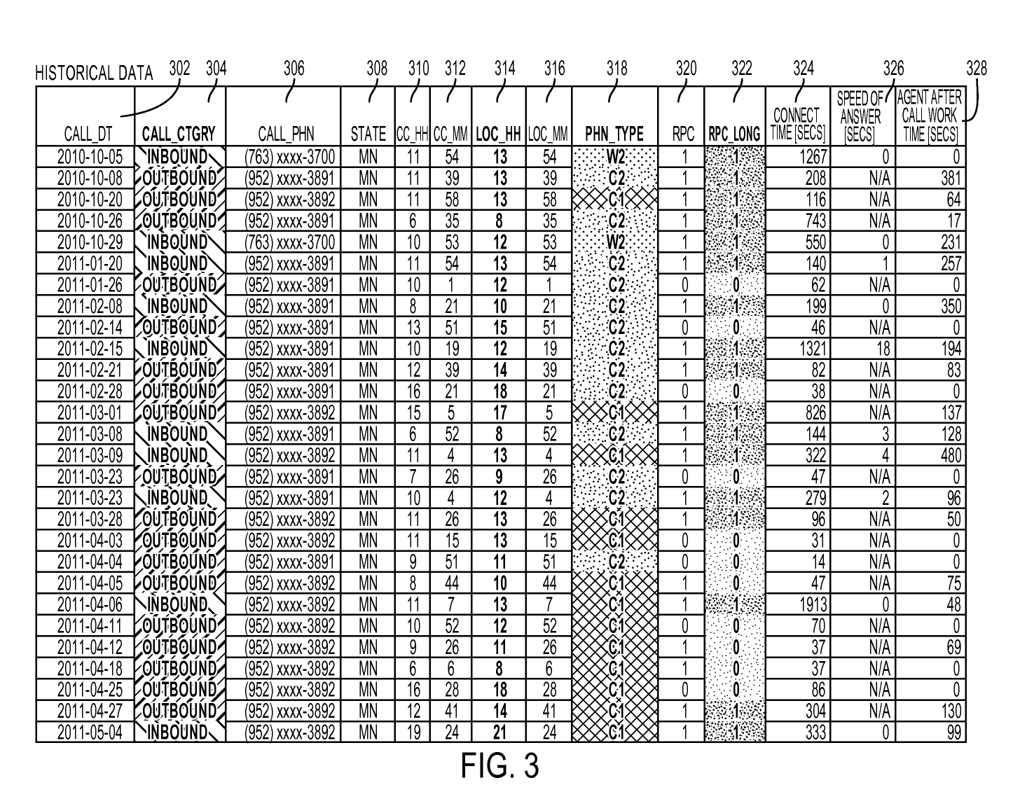

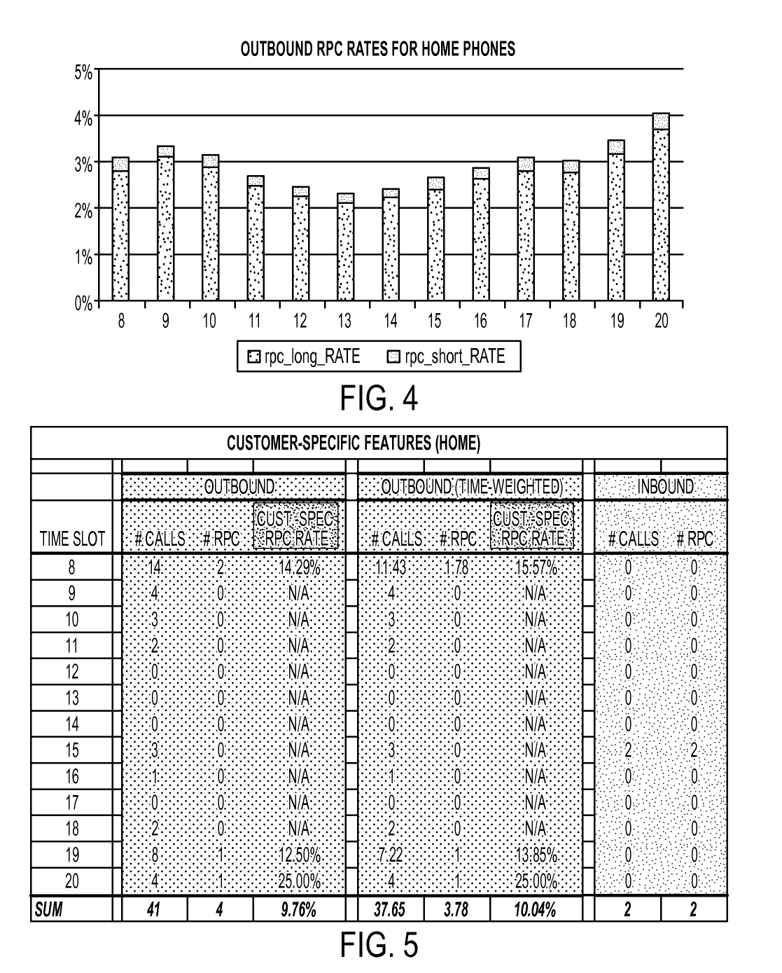

FIG. 4 shows a baseline associated with outbound RPC rates for home phones (e.g., 210 in FIG. 2) in one embodiment of the present disclosure. Baseline refers to the data statistics obtained by analyzing the overall historical data. The x-axis denotes hourly interval of calling time and the y-axis shows the outbound RPC rates. FIG. 5 shows customer-specific features for home phones (e.g., 218 in FIG. 2) in one embodiment of the present disclosure. The customer-specific features shown in FIG. 5 include outbound and inbound call patterns and time weighted patterns (e.g., less weight given to older calls).

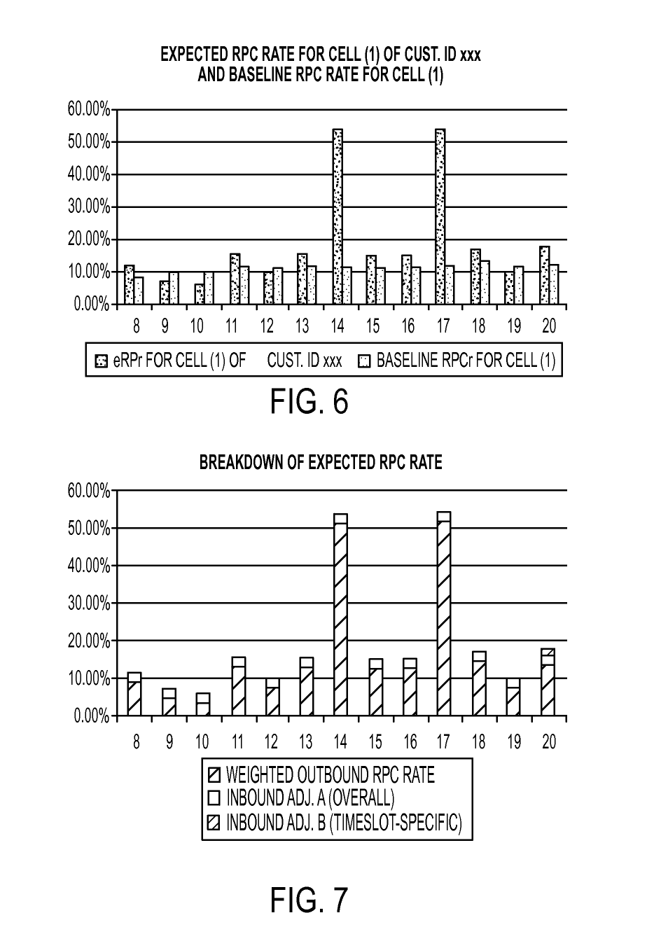

FIGS. 6 and 7 show the results of best time to contact (BTTC) model of the present disclosure in one embodiment. FIG. 6 shows an expected RPC rate for cellular phone for a customer and baseline RPC rate for the cellular phone as an example. Based on data availability, the baseline may be mixed with customer-specific features as follows:

R_{w}(pt,ts,cid)=

u(n(cid,ts))·Rₛ(cid,ts)

+(1−u(n(cid,ts)))·R_{b}(pt,ts)

where pt indicates the phone type, ts the time slot, cid the Customer ID, n( ) the count of contact attempts (or the sum of time-weighted contact attempts), u( ) the mixing weight for customer-specific vs. baseline information, Rₛ the customer-specific historical RPC rate, and R_{b} the overall baseline rate. The result R_{w} is then adjusted for additional factors such as inbound information. The expected RPC rate (eRPCr) may then be determined as follows:

eRPCr(pt,ts,cid)=

R_{w}(pt,ts,cid)

+I_{—}ib(cid)*A(pt)

+I_{—}ibts(cid,ts)*v(cid,ts)*B(pt,ts)

where A( ) and B( ) are the overall and timeslot-specific inbound adjustments, respectively, I_ib( ) is an indicator function taking on a value of 1 if the customer has had at least one historical inbound contact and 0 otherwise, I_ibts( ) is an indicator function taking on a value of 1 if the customer has had at least one historical contact attempt in a certain time period, and 0 otherwise, and v is a recency weight determined by how far in the past the latest inbound call in a certain time slot took place.

FIG. 7 shows the breakdown of the resulting expected RPC rate.

The BTTC model of the present disclosure may be employed or applied in a call center setting. For instance, a call center agent needing to contact a customer may run the model, which provides a customer-specific score, indicating the likelihood of having a successful contact for different times of the day. The BTTC model of the present disclosure may be also employed by an interactive voice response system which automatically places a call to the customers. Such interactive voice response system may automatically trigger the BTTC model of the present disclosure to determine the appropriate or best time to contact the customer, then based on such determination, automatically contact the customer during the “best” or one of the good/recommended periods of time.

The present disclosure in one embodiment expands the scope: “Best Time To Reach” and provides a methodology that is applicable to complete contact analytics efforts, e.g., including but not limited to, phone calls, e-mail, paper mail, facsimile (fax), text messages (e.g., SMS), instant messages, and others. The present disclosure may provide recommendations for all levels of data availability and mix baseline with individual information. The recommendations in the present disclosure may be based on a statistical model (e.g., as opposed to “business rules”) combining different data types and making use of historical call and outcome patterns, historical outbound RPC patterns, historical inbound RPC patterns, personal characteristics, aggregated call duration by time slot, aggregated inbound wait time by time slot, occupancy status, employment status and others.

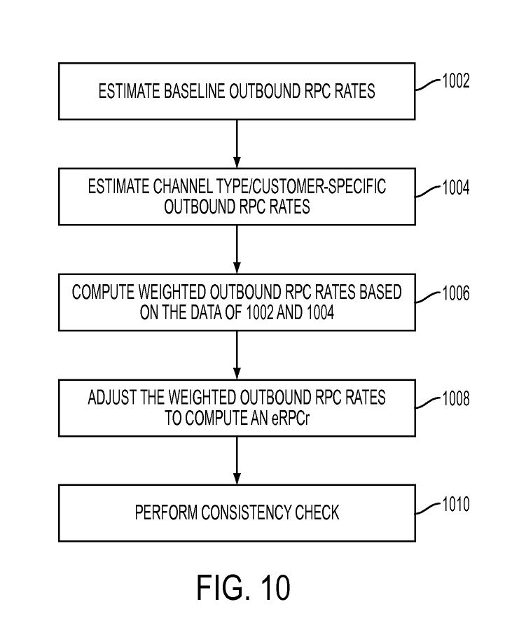

FIG. 10 is a flow diagram illustrating a method of determining best time to reach a customer in one embodiment of the present disclosure. The following describes with reference to FIG. 10, a model that estimates RPC rates (eRPCr), whose results, for example, are shown in FIGS. 6 and 7.

Referring to FIG. 10, at 1002, the baseline outbound RPC rates is estimated, for instance, based on historical data. In one embodiment of the present disclosure, the baseline outbound RPC rates, R_{b}(pt, ts), are estimated for different phone types (pt) and time slots (ts). They will serve as the overall default value in eRPCr model, if no historical contact data is available at all for a certain customer. In the example version presented here, the different phone types are Home phone (H), Cell phone (C), Work phone (W), and Other phone (O). It is noted that additional phone types may be contemplated, for instance, an even more detailed phone type breakdown. In a situation, where a customer is a household with a primary and secondary contact person, this could be indicated by two work phone types and two cell phone types. In the examples described below, a customer is identified by a customer number, however, it is noted that the present disclosure may work with and may be applied to other types of applications, where an Account ID, telephone number, Social Security Number, etc. serves as the main identifier. As an example, consider one hour time slots which range from 8 am to 9 pm and which are denoted in military time. For instance, a time slot value of 15 indicates the time between 3:00 pm and 3:59 pm.

| Ts | R_{b}(H, ts) | R_{b}(C, ts) | R_{b}(W, ts) | R_{b}(O, ts) |
|---|---|---|---|---|
| 8 | 2.91% | 8.37% | 2.21% | 0.78% |
| 9 | 3.69% | 10.05% | 2.35% | 1.32% |
| 10 | 3.02% | 10.25% | 3.50% | 1.01% |
| 11 | 2.72% | 12.06% | 3.68% | 1.09% |
| 12 | 2.55% | 11.35% | 2.99% | 1.20% |
| 13 | 2.26% | 12.07% | 3.20% | 1.54% |
| 14 | 3.00% | 11.67% | 2.65% | 1.47% |
| 15 | 3.03% | 11.83% | 2.78% | 1.45% |
| 16 | 3.47% | 11.95% | 2.55% | 1.44% |
| 17 | 3.76% | 12.47% | 2.77% | 0.99% |
| 18 | 2.84% | 13.93% | 1.17% | 0.89% |
| 19 | 3.49% | 12.32% | 1.06% | 1.00% |
| 20 | 3.85% | 12.89% | 1.15% | 0.71% |

The above table shows the baseline outbound RPC rates, R_{b}(pt, ts), for different phone types (pt) and different time slots (ts). For instance, the baseline outbound RPC rate for Work phones for the 4:00 PM-4:59 PM time slot is denoted as R_{b}(W, 16) and has been estimated (in this example) to be 2.55%.

In general, the baseline outbound RPC rates are defined as the proportion of successful contacts for a given phone type in a given time slot using all the of historical contact data for es-timation:

R_{b}(pt,ts)=(number of successful contacts using phone type pt in time slot ts)/(number of contact attempts using phone type pt in time slot ts)

Alternatively, the baseline outbound RPC rate may be defined as the ratio of the (a) the sum of time-weighted successful contacts using phone type pt in time slot ts and (b) the sum of time-weighted contact attempts using phone type pt in time slot ts.

At 1004, phone type/customer-specific outbound RPC rates are estimated. For instance, the following describes estimation of phone type/CustomerID-specific outbound RPC rates as an example. In the example version described herein, the individual-level information is computed on a PhoneType/CustomerID basis. Therefore, multiple phone numbers of the same phone type are aggregated for the same Customer ID. For instance, if multiple home phone numbers exist for a given Customer ID, they may all be aggregated to the same pt_lid (Phone-Type/CustomerID) identifier. CustomerID in this example identifies a customer. Other identifi-ers may be used. Thus, there is flexibility in the choice of the identifier used for generating cus-tomer-specific information. For example, the BTTC model may use the phone number instead of the Customer ID as the main identifier. In any case, the methodology described in this disclosure would be analogous. The phone type/CustomerID-specific outbound RPC rates, Rₛ(pt_lid, ts), are determined for each pt_lid and time slot (ts). In one embodiment, this involves weighting the available data in order to put more emphasis on recent information.

Weighting function for Count of Calls and Count of RPCs

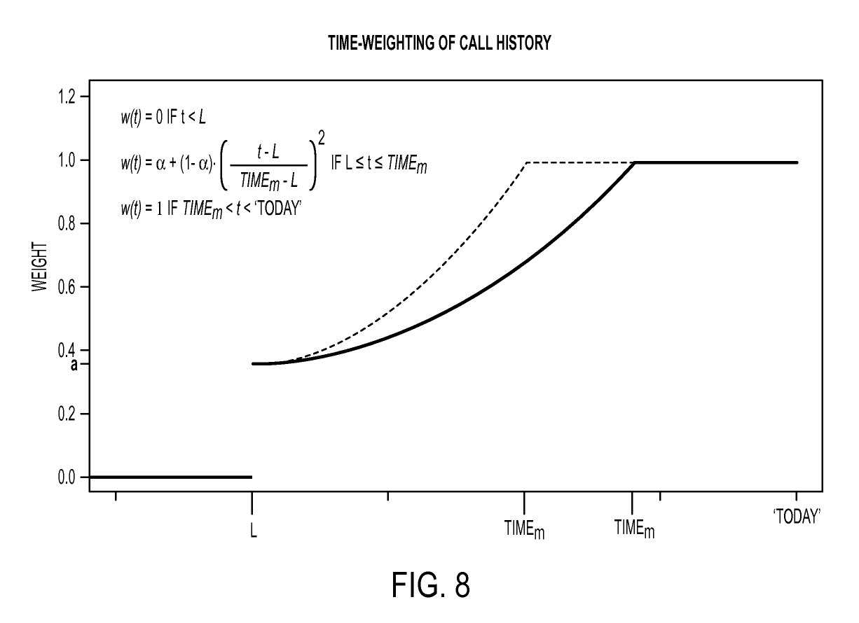

The following derives the weighting function wₚₜ_{_{—}}_{lid,ts}(t) for one particular phoneType/CustomerID in one particular time slot. To improve readability in this section, the indices pt_lid and ts are dropped and the weighting function will be denoted w(t). The mathematical formula of w(t) is given in FIG. 8, where
m denotes the number of the most recent calls that will attain a maximum weight of 1. For example, if m=5, the 5 most recent outbound phone calls for pt_lid in timeslot ts will have weight w(t)=1.
The date/time of the m^{th} most recent call will be denoted Timeₘ.
Weighting function parameters:
   Parameter for the left cut-off for the historical data will be denoted L. For instance, if only the most recent 1 year of data is used, then L=‘Today’-1 year
The parameter controlling the weight at time L will be denoted a. For instance, if a=0.35, then phone calls placed at time L will have weight L and calls placed between L and Timeₘ will have a weight between a and 1. Calls placed before L will have weight 0 (i.e., they are ignored).
Let t denote the call date and w(t) the weight attributed to a phone call placed at time t.

FIG. 8 illustrates time-weighing of call history in one embodiment of the present disclosure. In the figure, it is shown that recent calls are given more weights. L here may denote 1 year. Thus, calls that are more than 1 year old are not taken into account, i.e., given weight of 0. The most recent calls are given weight of 1. Here, m denotes a predetermined number of calls.

Computation of Phone Type/CustomerID-Specific Outbound RPC Rates

Given the weighting function wₚₜ_{_{—}}_{lid,ts}(t), the outbound RPC rates for phone type/CustomerID pt_lid in time slot ts can be computed as:

$${R}_{s} ( pt\_lid , ts ) = \frac{{Σ}_{τ \text{:} all available successful RPCs for pt\_lid in time slot ts} {w}_{pt\_lid , ts} ( τ )}{{Σ}_{t \text{:} all available calls for pt\_lid in time slot ts} {w}_{pt\_lid , ts} ( t )}$$

Referring to FIG. 10, at 1006, weighted outbound RPC rates are computed as follows.

Mixing Weight Between Baseline and Phone Type/CustomerId-Specific Information

The mixing weight for the phone type/CustomerID-specific RPC rate Rₛ(pt_lid, ts) will be denoted u(n(pt_lid, ts)), where n(pt_lid, ts) is the sum of time-weighted calls for a given pt_lid and time slot ts:

$$n ( pt\_lid , ts ) = {Σ}_{t \text{:} all available calls for pt\_lid in time slot ts} {w}_{pt\_lid , ts} ( t )$$

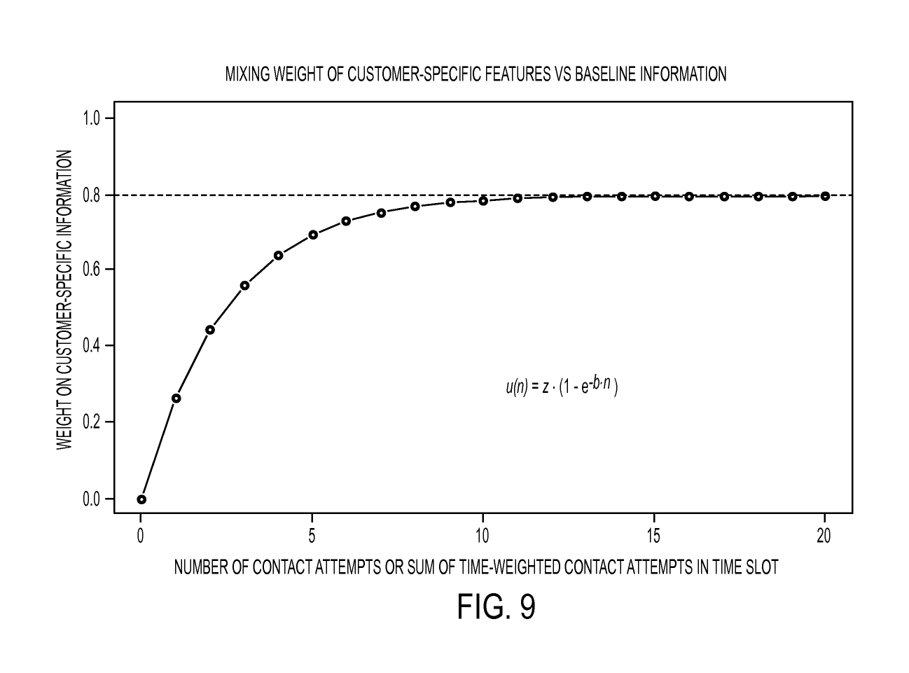

The mathematical formula for the mixing weight u can be found in FIG. 9. Conversely, since u takes on a value between 0 and 1, the baseline outbound RPC rate has weight 1−u(n(pt_lid, ts)). The parameters of the mixing weight u are:
parameter z, controlling the maximum weight for phone type/CustomerID-specific information. For instance, z=0.8
parameter b controlling the curvature of the mixing weight function, here b=0.4.

FIG. 9 illustrates mixing of baseline information and customer-specific features in one embodiment of the present disclosure. In this figure, as the number of contact attempts increases, more and more weight is given of customer-specific information. For instance, if more than 10 contact attempts are available in customer-specific information, a value very close to the predetermined weight z (e.g., z=0.8) is given. Here, z denotes maximum weight that can be given to the customer-specific information, and b controls the curvature of the mixing weight function.

Computation of the Weighted Outbound RPC Rate

The weighted outbound RPC rate will be denoted as R_{w}(pt, ts, pt_lid) and is computed as follows:

R_{w}(pt,ts,pt_{—}lid)=u(n(pt_{—}lid,ts))·Rₛ(pt_{—}lid,ts)+(1−u(n(pt_{—}lid,ts)))·R_{b}(pt,ts)

Referring to FIG. 10, at 1008, the weighted outbound RPC rates are adjusted to compute an eRPCr as follows.

An Additive Model for the eRPCr

An embodiment of the present disclosure may use an additive model for the expected right party contact (RPC) rate (eRPCr):

eRPCr(pt,ts,pt_{—}lid)=R_{w}(pt,ts,pt_{—}lid)+I_{—}ib(pt_{—}lid)*A(pt)+I_{—}ibts(pt_{—}lid,ts)*v(pt_{—}lid,ts,d)*B(pt,ts)

The main component of the eRPCr model in one embodiment is the weighted outbound RPC rate R_{w}(pt, ts, pt_lid), which depends on the phone type, the time slot and the phone type/CustomerID. The eRPCr is then adjusted for pt_lid's with at least one inbound phone call and there is an additional (interaction) adjustment if at least one inbound call occurred in the time slot ts.

Components of the eRPCr model may include:

pt: phone type, either H, C, W, or O.
ts: time slot, a number between 8 and 20.
pt_lid: PhoneType/CustomerID, e.g “C1_{—}12345678”.
I_ib(pt_lid): indicator variable with value 1 if the phone type/CustomerID pt_lid has been used at least once for an inbound call and 0 otherwise.
I_ibts(pt_lid, ts): indicator variable with value 1 if the phone type/CustomerID pt_lid has been used at least once for an inbound call in time slot ts and 0 otherwise.
v(pt_lid, ts): recency weight, depending on the date of the last inbound phone call from phone type/CustomerID pt_lid during time slot ts.
R_{w}(pt, ts, pt_lid): weighted outbound RPC rate for phone type pt, time slot ts, and phone type/CustomerID pt_lid.
A(pt): adjustment factor for phone numbers of type pt with at least one inbound call.
B(pt, ts): adjustment factor for phone numbers of type pt with at least one inbound call in time slot ts.

The recency weight v(pt_lid, ts), is defined as

$$v ( pt\_lid , ts ) = 0.4 + 0.6 \cdot \frac{[ Date of last inbound call using from pt\_lid during ts ] - [ L ]}{[ “ Today ” ] - [ L ]}$$

if the last inbound phone call occurred on or after the Left cut-off date L and zero otherwise.

In one embodiment, similar to the baseline outbound RPC rate R_{b}(pt, ts), the parameters A(pt) and B(pt, ts) are estimated using the available data. The following describes one way to determine A(pt) and B(pt, ts):

1. For each phone type and combining all time slots, measure the outbound RPC rate for phone type/CustomerID's that had at least one inbound phone call since ‘Today-L’ and call it r_with. Compute the same outbound RPC rate for all phone type/CustomerID's that did not have at least one phone call since “Today-L” and call it r_without. Define A(pt)=(r_with−r_without)/2
2. For each phone type and time slot, measure the outbound RPC rate for phone type/CustomerID's that had at least one inbound phone call since ‘Today-L’ and call it r_with2. Compute the same outbound RPC rate for all phone type/CustomerID's that did not have at least one phone call since “Today-L” and call it r_without2. Define B(pt,ts)=(r_with2−r_without2)−A(pt)

Example of inbound parameters with four different phone types and time slots:

| A(H) | A(C) | A(W) | A(O) |
|---|---|---|---|
| 1.63% | 3.67% | 1.86% | 4.35% |

| ts | B(H, ts) | B(C, ts) | B(W, ts) | B(O, ts) |
|---|---|---|---|---|
| 8 | 3.15% | 3.19% | 1.31% | −1.70% |
| 9 | 3.59% | 3.29% | 1.02% | −2.25% |
| 10 | 3.31% | 3.14% | 1.45% | −2.90% |
| 11 | 3.21% | 2.31% | 1.49% | −1.32% |
| 12 | 2.63% | 1.41% | 2.89% | −2.11% |
| 13 | 2.92% | 1.22% | 1.70% | −3.61% |
| 14 | 2.21% | 1.07% | 0.60% | −3.52% |
| 15 | 2.59% | 1.78% | 0.30% | −2.99% |
| 16 | 1.51% | 1.76% | 1.82% | −3.12% |
| 17 | 2.27% | 2.22% | 11.61% | −2.23% |
| 18 | 1.34% | 2.01% | −3.55% | −2.17% |
| 19 | 1.51% | 3.50% | −0.61% | −3.07% |
| 20 | 3.33% | 1.96% | −3.23% | −1.92% |

At 1010, a consistency check may be performed as follows.

Optionally, the above algorithm may check and adjust if needed, the values for the eRPCr that are unreasonable, i.e., outside the range (0%, 100%), which may have resulted from the additive model. For instance, one may overwrite any eRPCr smaller than a positive, non-zero lower threshold (such as 0.25%) and set it equal to that lower threshold. Similarly, one can set all the eRPCr values larger than an upper threshold (which is smaller than 100%) and set it to that upper threshold (e.g., upper threshold=90%).

In one embodiment of the present disclosure, instead of using ‘raw’ RPC flags, the BTTC model can be estimated using “Long RPC” flags. A “Long RPC” is defined as an RPC with a connect time of at least a predetermined time interval, e.g., 60 seconds. The assumption is that some outbound calls will reach the right party, however, the person reached might quickly indicate that this is not a convenient time to talk. Using “Long RPC” flags allows the BTTC model to account for this.

In one aspect of the BTTC model, the BTTC probabilities are defined on the destination time of the customer (or the location of the property corresponding to the Customer ID, e.g.). Therefore, the call center times are converted into local destination times before running the BTTC model. This time conversion also may handle the daylight saving time adjustments.

Phone Numbers not Found in Database

In one embodiment of the present disclosure, if a phone type/CustomerID has no call history, the BTTC model may use the phone type-specific baseline rate R_{b}(pt, ts).

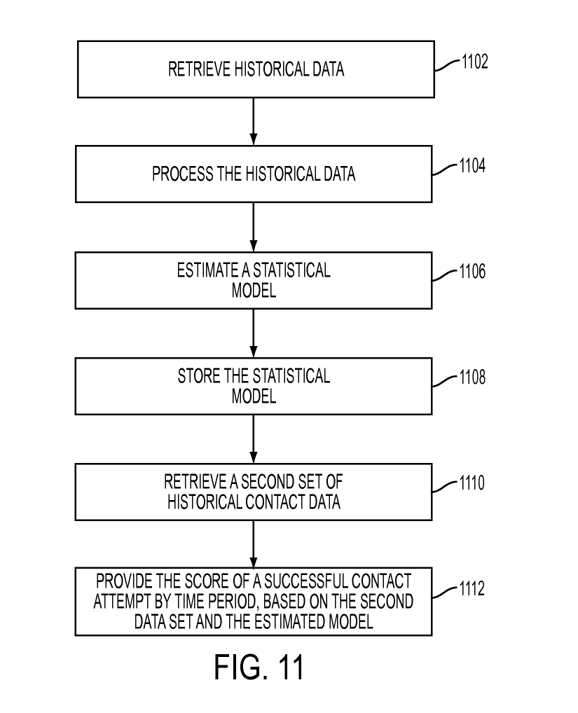

FIG. 11 illustrates an overall methodology in one embodiment of the present disclosure. At 1102, historical contact data may be retrieved or received. The contact data in one embodiment of the present disclosure may include a field identifying the customer, an indication for the time period of the historical contact (e.g., 1-hour time slots between 8 am and 9 pm, a breakdown like Morning/Lunch/Afternoon/Evening, the day of the week, or another time period) and an indicator variable recording whether the contact attempt was successful. The indicator variable in one embodiment of the present disclosure is binary (e.g., a variable that takes on the values 0/1, True/False, Success/Failure, or others) and the value it represents may depend on the situation or channel. For example, for a fax (facsimile) communication, the target variable may be whether the customers took a specific action within a specified period of time. For electronic mails (E-Mails), it may be whether the customers clicked on a link or responded to the email within a specified period of time. The specified period of time may be the same or different for the different types of communication medium (e.g., fax, e-mail, instant messaging, phone calls). For outbound calls in a contact center, it may be whether there has been a “Right Party Contact” or a Right Party Contact where the interaction lasted at least a certain time, such as one minute. The contact data might include additional variables such as phone type (work, home, cell) or email type (work, private, Facebook™). For phone calls, this can include at least two types of additional information: (a) additional information about the call (such as the weekday) or the duration of the call and (b) additional information about the customer (e.g., credit score, balance, delinquency status, days since the last contact and others).

At 1104, the historical contact data may be processed to be used as inputs for a statistical model. This processing might include aggregation, arithmetic transformations such as log, square root, categorization, and/or others. In the following description, this processing step is described with reference to a call center example. It should be understood, however, that the methodology of the present disclosure is not limited to the application in a call center. Aggregation can take place many different levels such as a customer level (total number of calls in the last year for a given customer), customer and phone type level (total number of calls in the last year using a particular phone type to a given customer), customer and time period level (cumulative call duration in last year broken down by time period), customer/time period/phone type level, and/or others.

At 1106, a statistical model may be estimated that predicts a successful contact using the data retrieved and processed at 1102 and 1104. “Statistical Model Estimation” is also referred to as “Model Training”, or “training a statistical model.” Different statistical models may be estimated and used. One is an additive model, that mixes an overall baseline rate with a customer-specific rate (depending on how much data is available for a customer and time period), for instance, as described above. Another model may employ a different statistical approach, e.g., Logistic Regression which estimates the coefficients of a relationship between the model features and a binary response variable, indicating whether the historical contact attempt had been successful or not. Yet another estimation may combine these two models by estimating a logistic regression, that takes the output of the additive model (or a transformation thereof, such as the Logit) as an input in addition to other variables such as historical cumulative call time, inbound wait time, weekday/weekend effect, and others. More statistical models exist and can be combined. The models (1) provide a score indicating the likelihood of a successful contact attempt (by time period) (2) they use historical contact data to estimate a model for providing aforementioned score, (3) they compute these scores as a function of inputs such as the Customer ID and the proposed time period/time slot for a contact attempt and possibly additional variables, such as the data from Step 1102 (e.g., phone type) or Step 1104 (aggregated call duration by customer and time period).

At 1108, the estimated model may be stored. At 1110, a second set of historical contact data is received or retrieved. The second set of historical contact data may include the same data received at 1102 or different data, or combinations thereof. The processed data associated with the customers on the list may be also received or retrieved. At 1112, the score indicating the likelihood of a successful contact attempt is computed based on the second data set and the estimated model.

As described above, a methodology is presented that in one embodiment utilizes customer identification and contact data available and processed from historical data to train a statistical model. The model is then used to provide a customer-specific score indicating the likelihood of a successful contact attempt for different time periods.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The systems and methodologies of the present disclosure may be carried out or executed in a computer system that includes a processing unit, which houses one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit by any techniques known or will be known to the skilled artisan for providing the computer program product to the processing system for execution.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer processing system that carries out the system and method of the present disclosure may also include a display device such as a monitor or display screen for presenting output displays and providing a display through which the user may input data and interact with the processing system, for instance, in cooperation with input devices such as the keyboard and mouse device or pointing device. The computer processing system may be also connected or coupled to one or more peripheral devices such as the printer, scanner, speaker, and any other devices, directly or via remote connections. The computer processing system may be connected or coupled to one or more other processing systems such as a server, other remote computer processing system, network storage devices, via any one or more of a local Ethernet, WAN connection, Internet, etc. or via any other networking methodologies that connect different computing systems and allow them to communicate with one another. The various functionalities and modules of the systems and methods of the present disclosure may be implemented or carried out distributedly on different processing systems or on any single platform, for instance, accessing data stored locally or distributedly on the network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for predicting likelihood of reaching a customer in a time period, comprising:
receiving a first set of historical customer contact data;
estimating a statistical model which computes a score for determining a successful contact with the customer for the time period based on the first set of historical customer contact data;
receiving a second set of historical customer contact data associated with at least one customer; and
providing the score of a successful contact for said at least one customer based on the second set of historical data and the estimated statistical model.

2. The method of claim 1, wherein the first set of historical customer contact data includes at least a customer identifier, time period of contact, and an indicator variable recording whether the contact was successful.

3. The method of claim 2, wherein the indicator variable records a successful contact including, for a fax communication or text message, whether customers took a specific action within a first specified period of time, for E-Mails, whether the customers clicked on a link or responded to an email within a second specified period of time, for a phone call in a contact center, whether there has been a Right Party Contact or a Right Party Contact where an interaction lasted for at least a predetermined time length, for a letter, whether the customers called a number within or sent back a form within a third specified period of time, for an instant message, whether the customer responded within a fourth specified period of time.

4. The method of claim 1, wherein the statistical model includes an additive model that mixes overall baseline scores with customer-specific scores for successful contact in the time period.

5. The method of claim 4, wherein the additive model performs:
estimating a baseline score based on the first set of historical data;
estimating a customer-specific score based on the first set of historical data;
determining a weighted score based on the baseline score and the customer-specific score;
adjusting the determined weighted score with one or more additional factors; and
providing the score of a successful contact based on the adjusted weighted score.

6. The method of claim 5, where the estimating a baseline score includes computing a proportion of successful contacts for a given channel type in a given time slot using the first set of historical data.

7. The method of claim 5, wherein the estimating a baseline score includes computing a ratio of (a) sum of time-weighted successful contacts using a given channel type in a given time slot and (b) sum of time-weighted contact attempts using a given channel type in given time slot.

8. The method of claim 5, wherein the step of estimating a customer-specific score includes computing for the customer a proportion of successful contacts for a given channel type in a given time slot using the first set of historical data.

9. The method of claim 5, wherein the step of estimating customer-specific score includes computing for the customer using a given channel type in given time slot using the first set of historical data a ratio of (a) sum of time-weighted successful contacts and (b) sum of time-weighted contact attempts.

10. The method of claim 5, wherein the step of determining a weighted score includes:
if call history associated with the customer is available,
determining a weight for mixing the baseline score and the customer-specific score; and
computing the weighted score based on the mixing weight, the baseline score, and the customer-specific score,
and if no call history associated with the customer is available,
computing the weighted score as the baseline score.

11. The method of claim 5, wherein the adjusting step includes adjusting with at least one overall inbound contact score adjustment and adjusting with at least one inbound contact score adjustment associated with a selected time slot.

12. The method of claim 1, wherein the step of estimating a statistical model includes:
processing the first set of historical customer contact data, by one or more of aggregation, transformation, categorization, or combinations thereof in order to generate a set of model features; and
estimating coefficients of a relationship between the model features and a response variable, the response variable defined as the indicator variable recording whether the contact was successful.

13. The method of claim 12, wherein the model features include total contact time per time period for each customer.

14. The method of claim 12, wherein the processing of the first set of historical customer contact data includes:
aggregating contact time per time period for each customer if a contact method is by phone;
aggregating total count of contacts if the contact method is email;
transforming the first set of historical contact data by a log, power, or identity transform;
categorizing based on channel type such as home phone, work phone, cell phone, other phone, if the contact method is by phone.

15. The method of claim 1, wherein the step of providing the score of a successful contact includes:
processing the second set of historical customer contact data by one or more of aggregation, transformation, categorization, or combinations thereof in order to generate a set of model features;
providing the score of a successful contact for said at least one customer based on the set of model features and the estimated statistical model.

16. A system for predicting likelihood of contacting a customer in a time period, comprising:
a processor;
a statistical model operable to run on the processor, the statistical model estimated based on a first set of historical customer contact data to compute a score for determining a successful contact with the customer for the time period;
a prediction module operable to receive a second set of historical customer contact data associated with at least one customer, and provide the score of a successful contact for said at least one customer based on the second set of historical data and the estimated statistical model.

17. The system of claim 16, wherein the first set of historical customer contact data includes at least a customer identifier, time period of contact, and an indicator variable recording whether the contact was successful.

18. The system of claim 17, wherein the indicator variable records a successful contact including, for a fax communication or text message, whether customers took a specific action within a first specified period of time, for E-Mails, whether the customers clicked on a link or responded to an email within a second specified period of time, for a phone call in a contact center, whether there has been a Right Party Contact or a Right Party Contact where an interaction lasted for at least a predetermined time length, for a letter, whether the customers called a number within or sent back a form within a third specified period of time, for an instant message, whether the customer responded within a fourth specified period of time.

19. The system of claim 16, wherein the statistical model includes an additive model that mixes overall baseline scores with customer-specific scores for successful contact in the time period.

20. The system of claim 19, wherein the additive model performs:
estimating a baseline score based on the first set of historical data;
estimating a customer-specific score based on the first set of historical data;
determining a weighted score based on the baseline score and the customer-specific score;
adjusting the determined weighted score with one or more additional factors; and
providing the score of a successful contact based on the adjusted weighted score.

21. The system of claim 20, where the estimating a baseline score includes computing a proportion of successful contacts for a given channel type in a given time slot using the first set of historical data.

22. A computer readable storage medium storing a program of instructions executable by a machine to perform a method of predicting likelihood of contacting a customer in a time period, comprising:
receiving a first set of historical customer contact data;
estimating a statistical model which computes a score for determining a successful contact with the customer for the time period based on the first set of historical customer contact data;
receiving a second set of historical customer contact data associated with at least one customer; and
providing the score of a successful contact for said at least one customer based on the second set of historical data and the estimated statistical model.

23. The computer readable storage medium of claim 22, wherein the first set of historical customer contact data includes at least a customer identifier, time period of contact, and an indicator variable recording whether the contact was successful.

24. The computer readable storage medium of claim 22, wherein the indicator variable records a successful contact including, for a fax communication or text message, whether customers took a specific action within a first specified period of time, for E-Mails, whether the customers clicked on a link or responded to an email within a second specified period of time, for a phone call in a contact center, whether there has been a Right Party Contact or a Right Party Contact where an interaction lasted for at least a predetermined time length, for a letter, whether the customers called a number within or sent back a form within a third specified period of time, for an instant message, whether the customer responded within a fourth specified period of time.

25. The computer readable storage medium of claim 22, wherein the statistical model includes an additive model that mixes overall baseline scores with customer-specific scores for successful contact in the time period, wherein the additive model performs:
estimating a baseline score based on the first set of historical data;
estimating a customer-specific score based on the first set of historical data;
determining a weighted score based on the baseline score and the customer-specific score;
adjusting the determined weighted score with one or more additional factors; and
providing the score of a successful contact based on the adjusted weighted score.
